(19) United States
(12) Patent Application Publication
(10) Pub. No.: US 2007/0068410 A1
(43) Pub. Date: Mar. 29, 2007

(54) Inking roller for an inking unit of an offset printing press

(75) Inventor: Franck Roland, BALGANY SUR THERAIN (FR)

Correspondence Address: DAVIDSON, DAVIDSON & KAPPEL, LLC, 485 SEVENTH AVENUE, 14TH FLOOR, NEW YORK, NY, 10018, US

(73) Assignee: GOSS INTERNATIONAL MONTATAIRE SA, MONTAIRE (FR)

(21) Appl. No.: 10/576,031

(22) PCT Filed: Oct. 15, 2004
(86) PCT No.: PCT/IB04/03374

§ 371 Date: Apr. 13, 2006

(30) Foreign Application Priority Data
Oct. 17, 2003 (DE) 103 48 307.1

(51) Int. Cl. B41F 31/02

(52) U.S. Cl. 101/365

(57) ABSTRACT

The invention provides an inking roller for an inking unit of an offset printing press. The inking roller has a number of zones arranged in the direction of the axis of rotation and at least one ink reservoir in the interior of the inking roller. The at least one ink reservoir in each of the number of zones is connected to at least one ink exit in the circumferential surface of the inking roller. Each zone in the interior of the inking roller is assigned at least one pumping element for conveying ink from the ink reservoir to the circumferential surface.

Priority to German Patent Application No. 103 48 307.1, filed Oct. 17, 2003, and incorporated by reference herein, is claimed hereby.

The invention relates to an inking roller for an inking unit of an offset printing press wherein the inking roller includes a number of zones arranged in the direction of the axis of rotation and at least one ink reservoir in the interior of the inking roller. In each of the number of zones, the at least one ink reservoir is connected to at least one ink exit in the circumferential surface of the inking roller.

In inking units of offset printing presses, ink is frequently supplied from an ink fountain or ink reservoir to a group of inking unit rollers by means of an ink fountain roller and ink metering devices arranged along the axis of rotation of the ink fountain roller. Different amounts of ink are generally supplied to different zones as governed by the individual ink metering devices allocated to the individual zones and as selected in accordance with the subject to be printed. Ink metering devices, in particular those equipped with a flap or a blade, are difficult to control or regulate. The ink film needs to be calibrated with high precision, and yet manufacturing tolerances result in a certain play and thus in settings that are difficult to reproduce after a certain time (in particular the zero setting), in particular if the ink metering device must be dismounted for maintenance work. In addition, the cost of such an ink metering element is considerable.

The document U.S. Pat. No. 6,234,078 B1 discloses an inking roller that is subdivided into a number of zones along its axis of rotation. Each zone has an ink reservoir in the interior of the inking roller. Ink from the ink reservoir can get to the circumferential surface of the inking roller.

It is an object of the present invention to provide an inking roller for applying ink to an inking unit of an offset printing press in a controlled manner, in particular for applying different amounts of ink to different zones of the inking roller.

According to the invention, this object is attained by an inking roller that has the features given in claim 1. Advantageous developments of the invention are characterized in the dependent claims.

An inking roller according to the invention for an inking unit of an offset printing press has a number of zones arranged in the direction of the axis of rotation of the inking roller and at least one ink reservoir in the interior of the inking roller. The at least one ink reservoir in each of the number of zones is connected to at least one ink exit in the circumferential surface of the inking roller in such a way that the ink present in the ink reservoir can get to the circumferential surface of the inking roller. At least one pumping element for conveying ink from the ink reservoir to the circumferential surface is assigned to each zone and located in each zone in the interior of the inking roller.

A pumping element can be easily controlled or regulated with closed-loop control. Thus a particular advantage of the invention is that the volume (or amount) of ink applied to the circumferential surface can be preset or predetermined. Apart from factors such as viscosity, temperature, and similar parameters, the volume of ink applied to the surface of the inking roller depends on the actuation timing of the pumping element. Thus the inking roller according to the invention advantageously permits ink to be applied to an inking unit at high precision and in a controlled manner.

The inking unit according to the invention represents a simple system that has only few components and does not cost much. Advantageously, the mounting of the inking roller requires less mechanical precision than in common ink metering devices.

The pumping element may be an electrical pump or a pneumatic pump. Additionally or alternatively, the ink exit may be an opening or a porous piece of material, in particular a sponge or a sieve-like or strainer-like mesh structure. In particular, the ink exit may comprise a perforated plug. According to an advantageous development, the ink exits may be designed in such a way that their sizes are variable.

In an advantageous embodiment, the inking roller may have an ink duct extending substantially along the axis of rotation of the inking roller into the interior of the inking roller to the at least one ink reservoir. The ink duct may have a rotary seal. Additionally or alternatively, the pumping element or pumping elements may be powered by a rotary electrical connection.

In an inking roller according to the invention, a zone may have a number of ink exits. In the circumferential direction, the ink exits may either be arranged in one angular region of the circumference in an accumulative way or be distributed in a substantially even way. An accumulation may be advantageous if the ink supply is to be dependent on the azimuthal angle of the circumference, whereas an even distribution is favorable to an ink supply that is substantially independent of the azimuthal angle of the circumference.

A particular advantage can be attained by the inking roller according to the invention if every pumping element of the number of pumping elements can be controlled independently of the other pumping elements. Thus a desired amount of ink can be applied in each zone independently of the amount of ink in the other zones, in particular the adjacent zones.

The invention also relates to an inking unit for an offset printing press. The inking roller according to the invention may in particular be used as an ink source replacing an ink fountain in combination with an ink fountain roller and ink metering elements in an inking unit. An inking roller according to the invention may also be used in a different position in a group of inking unit rollers, for example in the position of the ink form rollers, which apply ink to a printing master cylinder. In other words, an inking unit according to the invention for an offset printing press is characterized by at least one inking roller according to the present description.

In addition, the basic idea of the invention also relates to an offset printing unit. The offset printing unit comprises at least one inking unit according to the invention. The offset printing unit may be a direct or indirect printing unit. Additionally or alternatively, the offset printing unit may operate according to the wet offset or dry offset process. The offset printing unit may be designed for processing sheets or webs. Typical types of printing stock are paper, cardboard, paperboard, organic polymer foils or fabrics. The offset printing unit may be part of a sheet-fed printing press, in particular of a perfecting press, or of a web-fed printing press, in particular a commercial printing press or a newspaper printing press. A sheet-fed printing press may comprise a feeder, a number of printing units, in particular four, six, eight or ten printing units, a finishing unit, if desired, (i.e. a die-cutting unit, a creasing unit, or a varnishing unit), and a delivery. A web-fed printing press may comprise a splicer, a number of printing units printing on the upper and lower side of the web, in particular four or six printing units, a drier, and a folder.

Other advantages and advantageous embodiments and developments of the invention will be given in the following figures and their descriptions. The figures include:

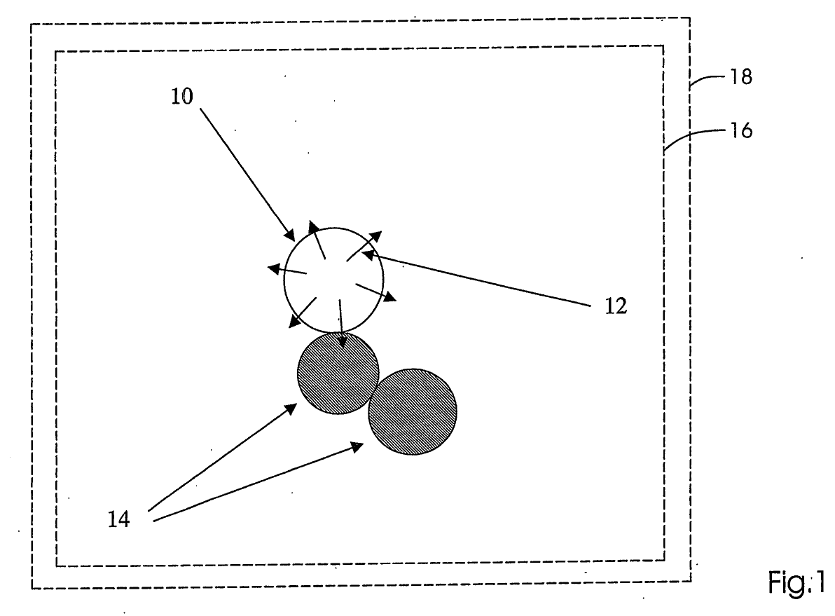

FIG. 1 showing a diagram for illustrating the principle the invention is based on, and

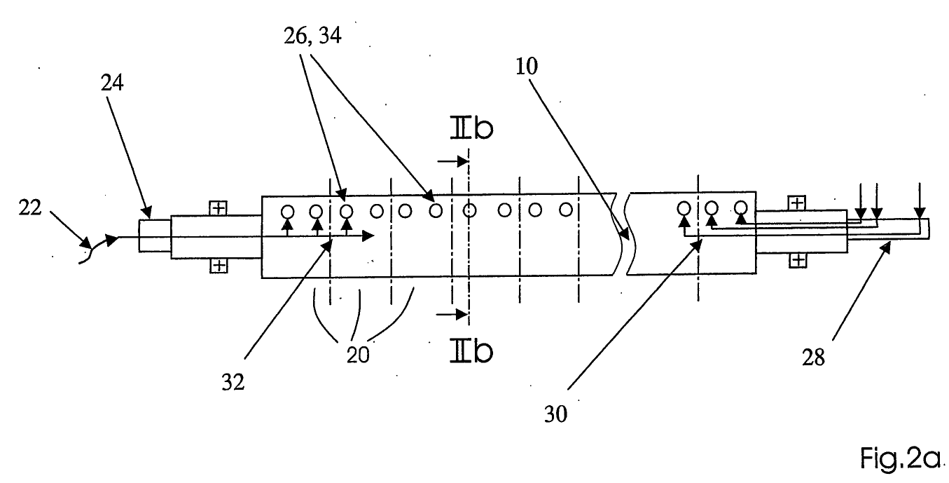

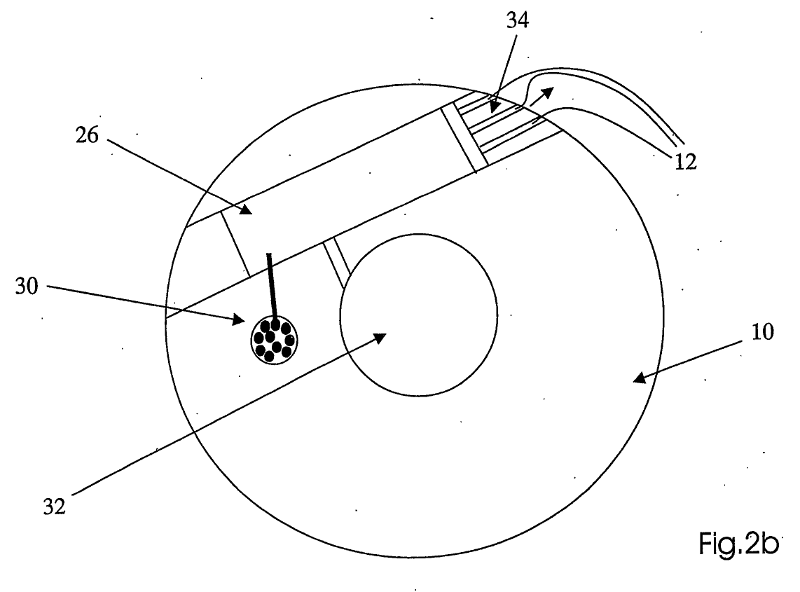

FIG. 2, which is subdivided into FIGS. 2A and 2B and shows a preferred embodiment of the inking unit according to the invention.

FIG. 1 is a diagram that illustrates the principle the invention is based on. In an inking unit 16 according to the invention and belonging to an offset printing press 18, an inking roller 10 is used as an ink source. Ink from the interior of the inking roller 10 reaches the circumferential surface of the inking roller 10. For this purpose, the inking roller 10 has a number of ink exits 12. The circumferential surface of the inking roller 10 rolls on another inking unit roller 14, which represents the beginning of a group of further inking unit rollers 14 that roll on each other and are not further illustrated here. The group of further inking unit rollers 14 is designed in such a way that, at the end of the group of inking unit rollers 14, a desired amount of ink is applied to a printing master on a printing master cylinder connected to the end of the group of inking unit rollers. In a preferred embodiment, the inking unit 16 is designed as what is referred to as a zone-type or zonal inking unit, i.e. in the direction of the axes of rotation of the inking roller 10 and of the further inking unit rollers 14, the inking unit is divided into zones or sections that apply different amounts of ink to the printing master. In each zone, the flow of ink through the ink exits 12 to the circumferential surface can be controlled and/or regulated (with closed-loop control) in a manner independent of the ink flows in the other zones. The distribution of the ink can in particular be controlled and/or regulated (with closed-loop control) in a manner corresponding to the ink density distribution on a printing substrate along its width (substantially parallel with the axes of rotation of the inking unit rollers 14).

FIG. 2, which is subdivided into FIGS. 2A and 2B, shows a preferred embodiment of the inking unit according to the invention.

FIG. 2A shows an inking roller 10 according to the invention. The inking roller 10 may be supported in an inking unit so as to rotate about the axis of the inking roller 10. Along its axis, the inking roller 10 is subdivided into zones 20. In other words, the circumferential surface of the roller 10 is divided into zones 20. In each zone 20, a pumping element 26 for pumping ink is located in the interior of the inking roller 10. In particular, the respective pumping element 26 assigned to one zone 20 is located within the respective zone 20. The pumping elements 26 are supplied with ink by an ink duct 22 extending through an inking unit journal that is equipped with a rotary seal 24. The ink duct 22 feeds ink to an ink reservoir 32 (cf. FIG. 2B) located in the interior of the inking roller 10. The pumping elements 26 are controlled electrically by means of a rotary electrical connection and via electrical lines 30 in the interior of the inking roller 10. The ink reaches the surface through perforated plugs 34.

FIG. 2B shows a diagrammatic cross section of the preferred embodiment of the inking roller 10 according to the invention. The tube-shaped ink reservoir 32 is substantially symmetrical with respect to the axis of rotation of the inking roller 10 and extends along and about the axis of rotation of the inking roller 10. Ink is supplied from the ink reservoir 32 to the pumping element 26, which is an electrical pump in the given example, of one zone via an ink duct. An electrical line 30 is used to control the pumping element 26. The pumping element 26 can be controlled in such a way that a desired and/or predetermined amount of ink reaches the surface of the inking roller 10 through the perforated plug 32 and the ink exits 12. The amount of ink that is pumped through the ink exits 12 in a given time depends, in particular, on the characteristics of the ink, for example on the viscosity, the temperature, and the pressure generated by the pumping element 26.

### LIST OF REFERENCE NUMERALS

10 inking roller
12 ink exit
14 further inking unit roller
16 inking unit
18 offset printing press
20 zone
22 ink duct
24 rotary seal
26 pumping element
28 rotary electrical connection
30 electrical line
32 ink reservoir
34 perforated plug

What is claimed is:

1-10. (canceled)

11: An inking roller for an inking unit of an offset printing press comprising:
a plurality of zones arranged in a direction of an axis of rotation; and
at least one ink reservoir in an interior of the inking roller,
the at least one ink reservoir in each of the plurality of zones is connected to at least one ink exit in a circumferential surface of the inking roller;
the inking roller having at least one pumping element assigned to each zone in the interior of the inking roller;
the pumping element for conveying ink from the ink reservoir to the circumferential surface.

12: The inking roller as recited in claim 11 wherein the pumping element is an electrical pump or a pneumatic pump.

13: The inking roller as recited in claim 11 wherein the ink exit is an opening or a porous piece of material.

14: The inking roller as recited in claim 13 wherein the ink exit includes a perforated plug.

15: The inking roller as recited in claim 11 further comprising an ink duct with a rotary seal, wherein the ink duct substantially extends along the axis of rotation of the inking roller into the interior of the inking roller to the at least one ink reservoir.

16: The inking roller as recited in claim 11 wherein the pumping element is powered by a rotary electrical connection.

17: The inking roller as recited in claim 11 wherein the at least one ink exit includes a number of ink exits present in one zone, the ink exits being located in a circumferential direction either in one angular section of a circumference in an accumulative way or distributed in a substantially even manner.

18: The inking roller as recited in claim 11 wherein each pumping element is controllable independently of the other pumping elements.

19: An inking unit for an offset printing press comprising at least one inking roller as recited in claim 11.

20: An offset printing unit comprising at least one inking unit as recited in claim 19.
